(19) United States
(12) Patent Application Publication
(10) Pub. No.: US 2018/0001895 A1
(43) Pub. Date: Jan. 4, 2018

(54) VEHICLE CONTROL SYSTEM AND METHOD

(71) Applicant: JAGUAR LAND ROVER LIMITED, Whitley,Coventry,Warwickshire (GB)

(72) Inventors: Andrew Fairgrieve, Rugby, Warwickshire (GB); James Kelly, Solihull, West Midlands (GB)

(73) Assignee: Jaguar Land Rover Limited, Coventry Warwick shire (GB)

(21) Appl. No.: 15/543,632

(22) PCT Filed: Jan. 12, 2016
(86) PCT No.: PCT/EP2016/050410

§ 371 Date: Jul. 14, 2017

(30) Foreign Application Priority Data
Jan. 15, 2015 (GB) 1500645.5

(51) Int. Cl. B60W 30/182; B60W 10/18; B60W 10/20; B60W 40/06; B60W 50/08; B60W 10/04; B60W 10/12; B60W 10/22; B60W 50/00

(52) U.S. Cl. CPC B60W 30/182; B60W 10/12; B60W 10/18; B60W 10/20; B60W 10/22; B60W 40/06; B60W 50/082; B60W 10/04; B60W 2420/42; B60W 2050/0075; B60W 2550/14; B60W 2710/0611; B60W 2710/125; B60W 2710/18; B60W 2710/20; B60W 2710/22; B60W 2750/40; B60W 2720/10

(57) ABSTRACT

A vehicle control system having a subsystem controller for initiating control of a first group of at least one vehicle subsystem in a selected one of a plurality of subsystem control modes each corresponding to one or more different driving conditions; and an estimator module for evaluating at least one driving condition indicator to determine the extent to which each of the subsystem control modes is appropriate and for providing an output indicative of the subsystem control mode that is most appropriate. The estimator module is configured to increase the probability to which the at least one off-road driving mode is determined appropriate in dependence on at least one terrain indicator. In an automatic response mode the subsystem controller selects the most appropriate one of the subsystem control modes for each subsystem of the first group in dependence on the output.

### INCORPORATION BY REFERENCE

The entire contents of co-pending UK patent application GB2499279, UK patents GB2325716, GB2308415, GB2341430, GB2382158, GB2492748, GB2492655 and GB2381597 and US2003/0200016 are expressly incorporated herein by reference.

### FIELD OF THE INVENTION

The present invention relates to a vehicle control system for one or more vehicle subsystems and to a method of controlling one or more vehicle subsystems.

### BACKGROUND

It is known to provide a vehicle having a plurality of subsystems which can be operated in different configurations to suit different driving conditions. For example, automatic transmissions may be controlled in a variety of modes such as sport, manual, winter or economy. In each mode, subsystem control parameters such as accelerator pedal response and conditions under which changes between gear ratios take place may be modified so as to suit the conditions of the terrain or the particular taste of the driver. It is also known to provide air suspensions with on-road and off-road modes. Stability control systems can be operated at reduced activity in certain modes so as to give the driver more direct control, and power steering systems can be operated in different modes to provide a varying level of assistance depending on driving conditions.

In a known vehicle control system allowing selection of control modes optimized for different driving conditions, mode selection is entirely manual. The control system (which may also be referred to as a terrain response (TR) control system) responds to a user request for operation in a given control mode according to the position of a control knob. If the control knob has been left in a given mode (such as a grass/gravel/snow (GGS) mode) at key-off then the control system will assume the GGS mode at the next key-on, unless the control knob has been adjusted. Thus the position of the control knob determines the control mode that will be assumed by the controller.

Embodiments of the present invention have automatic mode selection functionality and may operate as described elsewhere herein. Embodiments of the invention may for example employ a multi-stable knob for mode selection, optionally of the kind described herein. In some embodiments the physical position of the knob is not indicative of selected mode.

It is to be understood that in some embodiments of the present invention the control system is able to determine confidently the type of terrain over which the vehicle is moving and determine the most appropriate control mode in a relatively short distance of travel (approximately less than two car lengths in some embodiments). When a vehicle moves from rest following key-on, the control system can therefore determine the most appropriate terrain relatively quickly and be ready to command a change in selected mode if required.

The present applicant has recognized that automatic mode selection functionality can be less reliable when incorporated into vehicles having manual transmissions.

It is desirable to provide an improved control system for a motor vehicle having automatic driving mode selection functionality and a manual transmission.

### SUMMARY

Embodiments of the invention may be understood with reference to the appended claims.

Aspects of the present invention provide a control system, a vehicle and a method.

In one aspect of the invention for which protection is sought there is provided a vehicle control system comprising:

a control means for initiating control of a first group of at least one vehicle subsystem in a selected one of a plurality of subsystem control modes, each of which subsystem control modes corresponds to one or more different driving conditions for the vehicle, the control modes including at least one on-road driving mode and at least one off-road driving mode;

evaluation means for evaluating at least one driving condition indicator to determine the extent to which each of the subsystem control modes is appropriate and for providing an output indicative of the subsystem control mode that is most appropriate, said at least one driving condition indicator including at least one terrain indicator indicative of the type of terrain over which the vehicle is travelling,

wherein said at least one terrain indicator comprises a signal indicative of whether one or more subsystems of a second group of one or more sub-systems is operational, the evaluation means being configured to increase the probability to which said at least one off-road driving mode is determined appropriate in dependence on the at least one terrain indicator; and wherein

in an automatic response mode said control means selects the most appropriate one of the subsystem control modes for the or each subsystem of the first group in dependence on the output.

The control means and the evaluation means may comprise at least one electronic processor having an electrical input for receiving said one or more signals each indicative of a driving condition indicator, and an electronic memory device electrically coupled to the electronic processor and having instructions stored therein, and wherein the evaluation means being configured to increase the probability to which said at least one off-road driving mode is determined appropriate in dependence on the at least one terrain indicator, and said control means selecting the most appropriate one of the subsystem control modes for the or each subsystem of the first group in dependence on the output, comprises the processor being configured to access the memory device and execute the instructions stored therein such that it is operable to increase the probability to which said at least one off-road driving mode is determined appropriate in dependence on the at least one terrain indicator and select the most appropriate one of the subsystem control modes.

Such a vehicle control system has the advantage that, when determining the most appropriate subsystem control mode, intelligent use may be made of information in respect of the user-selected state of one or more vehicle subsystems that may be selected by a driver when driving off-road and not when driving on-road, such as an off-road navigation system, an off-road cruise control system, an off-road camera system, or other off-road driving aid. The control system employs the information in order to determine the most appropriate subsystem control mode for the or each vehicle subsystem of the first group, increasing the likelihood that the most appropriate control mode is selected for the or each subsystem.

It is to be understood that by the term type of terrain is meant the material comprised by the terrain over which the vehicle is driving such as asphalt, grass, gravel, snow, mud, rock and/or sand. By off-road is meant a surface traditionally classified as off-road, being surfaces other than asphalt, concrete or the like. For example, off-road surfaces may be relatively compliant surfaces such as mud, sand, grass, earth, gravel or the like. Alternatively or in addition off-road surfaces may be relatively rough, for example stony, rocky, rutted or the like. Accordingly in some arrangements an off-road surface may be classified as a surface that has a relatively high roughness and/or compliance compared with a substantially flat, smooth asphalt or concrete road surface.

It is to be understood that one or more subsystems of the second group may be operable in a plurality of active modes and/or a plurality of inactive modes. Inactive modes may include a standby mode and an ‘off’ mode. The ‘off’ mode may correspond to a condition in which power to the subsystem is turned off, for example by means of an ‘on/off’ switch associated with the subsystem. For example, power may be available for supply to the subsystem, but an on/off switch associated with the subsystem may be in an off state.

In the case of a subsystem that is selected by means of a display screen, for example by means of a selector button associated with a display screen, such as a softkey, or by means of a touch-screen, the subsystem may be considered to be inactive when operation of the system has not been selected. The subsystem may be considered to be active if operation of the system has been selected.

The subsystem controller may be a central controller which as well as initiating control in the most appropriate of the plurality of control modes by selecting the most appropriate one, is also arranged to control the or each of the vehicle subsystems in said selected control mode. Alternatively the subsystem controller may initiate control of the vehicle subsystems in the selected one of the control modes via an intermediate controller which then controls the vehicle subsystems in the selected control mode. A different intermediate controller may be associated with each vehicle subsystem. The or each intermediate controller may form an integral part of the subsystem controller.

It may be that only one of a plurality of vehicle subsystems is controlled by the subsystem controller (or the intermediate controller) in the most appropriate control mode, depending on driving conditions.

Optionally a plurality (i.e. two or more) driving condition indicators are provided to the evaluation means.

In one embodiment, at least one driving condition indicator is derived from a signal indicative of the terrain in which the vehicle is travelling. Each of the different driving conditions with which the different subsystem control modes is associated may therefore be representative of or appropriate for at least one terrain type. For example, grass, gravel and snow may be associated with one of the subsystem control modes and mud and ruts may be associated with another of the subsystem control modes.

The vehicle control system may be configured to receive an input indicative of the operational state of the one or more subsystems of the second group.

Optionally, the subsystems of the second group include at least one selected from amongst an off-road speed control system, an off-road navigation system and an off-road camera system.

Optionally, the operational states of the second group of one or more subsystems include at least one active state and at least one inactive state.

Optionally, the operational state of at least one subsystem of the second group corresponds to a user-selectable operational state of the subsystem.

Optionally, the evaluation means is configured to increase the probability that an off-road driving mode and not an on-road driving mode is selected when a subsystem of the second group is in an active state.

Optionally, the evaluation means is arranged to determine the probability that each of the subsystem control modes is appropriate, and wherein the output provided by the evaluation means is indicative of the subsystem control mode with the highest probability.

Optionally, the subsystem controller is also arranged to control the or each of the vehicle subsystems in the selected one of the plurality of control modes.

As noted above, the evaluation means may be configured for evaluating a plurality of driving condition indicators.

Optionally, at least one of the driving conditions is representative of at least one terrain type.

Optionally, at least one of the driving condition indicators may be derived from a signal indicative of the terrain over or in which the vehicle is travelling.

Optionally, at least one of the driving conditions to which each of the subsystem control modes corresponds may be representative of a driving characteristic of the driver of the vehicle.

Optionally, at least one of the driving condition indicators may be derived from one or more signals indicative of a driving characteristic of the driver of the vehicle.

Optionally, the evaluation means may include estimator means for receiving one or more input signals corresponding to a respective one or more of the driving condition indicators and for estimating one or more further driving condition indicators on the basis of the or each of the input signals.

Optionally, the evaluation means further includes means for calculating a combined probability value for each subsystem control mode based on individual probability values, for said subsystem control mode, derived from a respective one of the driving condition indicators, the control output signal from the evaluation means being indicative of the control mode with the highest combined probability value, wherein the probability value for at least one said at least one off-road driving mode is adjusted to favor said at least one off-road driving mode in dependence on at least one said at least one terrain indicator that comprises a signal indicative of whether one or more subsystems of a second group of one or more sub-systems is operational.

Thus it is to be understood that, in some embodiments, when the at least one terrain indicator that comprises a signal indicative of whether one or more subsystems of a second group of one or more sub-systems is operational has a value indicating a subsystem of the second group is active, the probability value for at least one said at least one off-road driving mode is adjusted to favor said at least one off-road driving mode. Thus if a terrain indicator indicates that a vehicle may be travelling over sand, a probability value for a sand driving mode may be increased, to favor selection of the sand driving mode over one or more other modes. If a terrain indicator indicates that a plurality of control modes may be appropriate, the probability value for each of those control modes may be increased.

It is to be understood that the control system may be configured to select from a plurality of off-road driving modes. One or more of the subsystems of the second group may be configured for use in a predetermined one or more but not all of the off-road driving modes. Accordingly, the system may be configured to adjust only the probability value of the predetermined one or more off-road driving modes for which a given subsystem of the second group is configured for use. Thus, if a given subsystem is configured only for use in a rock crawl scenario, the system may increase the probability that a rock crawl driving mode is more likely, if that subsystem is in an active mode or in-use mode. In some embodiments the probability value may be adjusted in favor of a given off-road driving mode in dependence on a combination of factors including the user-selected state of a given subsystem of the second group. For example, if a vehicle speed is less than a predetermined value and an off-road camera system is operational, the probability that an off-road driving mode appropriate for low speed negotiation of a rocky surface is most appropriate may be increased. For example, in some embodiments the probability that the most appropriate driving mode is a ‘rock crawl’ driving mode may be increased in such circumstances.

Optionally, the combined probability value (Pb) for each control mode is calculated by:

Pb=(a.b.c.d. . . . n)/((a.b.c.d . . . n)+(1−a).(1−b).(1−c).(1−d). . . . (1−n))

wherein a, b, c, d . . . n represent the individual probability values derived from respective ones of the driving condition indicators.

It is to be understood that certain driving condition indicators may make a control mode more or less likely when combined together, compared with basing the selection on just a single driving condition indicator alone. It is therefore advantageous if the automatic response is based on a combined probability value dependent on a plurality of different driving condition indicators, rather than relying on a probability value for just one driving condition indicator.

Optionally, the vehicle control system comprises:

means for calculating, for each of the control modes, a difference value between the probability for the current control mode and the probability for another control mode,

means for integrating each of the difference values with respect to time to calculate an integrated difference value for each of the other control modes,

comparison means for comparing each of the integrated difference values with a threshold for change, and

means for initiating a change in the selected subsystem control mode when the integrated difference value for one of the control modes exceeds the threshold for change.

Optionally, the comparison means compares each of the integrated difference values with a plurality of thresholds for change and wherein the means for initiating a change in the selected subsystem control mode is operable to initiate a change when a first one of the thresholds for change is reached.

The means for calculating, the means for integrating, the comparison means, and the means for initiating may comprise: the processor being configured to access the memory device and execute the instructions stored therein such that it is operable to: calculate, for each of the control modes, a difference value between the probability for the current control mode and the probability for another control mode; integrate each of the difference values with respect to time to calculate an integrated difference value for each of the other control modes, compare each of the integrated difference values with a threshold for change; and initiate a change in the selected subsystem control mode when the integrated difference value for one of the control modes exceeds the threshold for change.

Thus, when a threshold for change is reached by one of the integrated difference values, the change in the selected subsystem control mode is initiated.

Optionally, each threshold for change is variable in dependence on a different driving condition indicator.

Optionally, one of the thresholds for change is dependent on a surface roughness of the terrain in which the vehicle is travelling.

Optionally, one of the thresholds for change is dependent on a rolling resistance of the terrain in which the vehicle is travelling.

It is an advantage of providing a variable threshold for change, dependent on different driving condition indicators, that the speed of response with which the control mode is selected can be varied according to the nature of the terrain in which the vehicle is travelling. This ensures that less control mode changes will be implemented in certain conditions (e.g. on-road terrain) compared to others (e.g. off-road terrain).

The vehicle control system may further include switching means for enabling switching between the automatic response mode in which the automatic control means controls the vehicle subsystems in dependence on the output automatically, and a manual response mode in which the subsystem control mode is selected by the driver manually.

Optionally, the at least one vehicle subsystem includes ones or more of: an engine management system, a steering controller, a brakes controller and a suspension controller.

In a further aspect of the invention for which protection is sought there is provided a vehicle comprising a vehicle control system according to an aspect of the present invention.

In one aspect of the invention for which protection is sought there is provided a vehicle comprising a body, a plurality of wheels, a powertrain to drive said wheels, a braking system to brake said wheels, and a system according to an aspect of the present invention.

In one aspect of the present invention for which protection is sought there is provided a method of controlling at least one vehicle subsystem of a vehicle, the method comprising:

initiating control of a first group of at least one vehicle subsystem in a selected one of a plurality of subsystem control modes, each of which corresponds to one or more different driving conditions for the vehicle, the control modes including at least one on-road driving mode and at least one off-road driving mode;

evaluating at least one driving condition indicator to determine the extent to which each of the subsystem control modes is appropriate;

providing an output indicative of the subsystem control mode that is most appropriate, said at least one driving condition indicator including at least one terrain indicator indicative of the type of terrain over which the vehicle is travelling, the at least one terrain indicator including a signal indicative of whether one or more subsystems of a second group of one or more sub-systems is operational,

the method comprising evaluating at least one said at least one terrain indicator that is indicative of the state of one or more vehicle sub-systems of the second group of one or more sub-systems and increasing the probability that an off-road driving mode and not an on-road driving mode is selected in dependence thereon; and

automatically selecting the most appropriate one of the subsystem control modes for the or each subsystem of the first group in dependence on the output.

Optionally, evaluating at least one driving condition indicator comprises determining the probability that each of the subsystem control modes is appropriate and providing an output indicative of the control mode with the highest probability.

In an aspect of the invention for which protection is sought there is provided a carrier medium carrying computer readable code for controlling a vehicle to carry out the method of a preceding aspect.

In one aspect of the invention for which protection is sought there is provided a carrier medium carrying computer readable code for controlling a vehicle to carry out the method of another aspect.

In one aspect of the invention for which protection is sought there is provided a computer program product executable on a processor so as to implement the method of another aspect.

In one aspect of the invention for which protection is sought there is provided a computer readable medium loaded with the computer program product of another aspect.

In one aspect of the invention for which protection is sought there is provided a processor arranged to implement the method of another aspect.

It is to be understood that a control mode may also be referred to as an operating mode.

It is to be understood that the controller or controllers described herein may comprise a control unit or computational device having one or more electronic processors. The system may comprise a single control unit or electronic controller or alternatively different functions of the controller may be embodied in, or hosted in, different control units or controllers. As used herein the term “control unit” will be understood to include both a single control unit or controller and a plurality of control units or controllers collectively operating to provide the stated control functionality. A set of instructions could be provided which, when executed, cause said computational device to implement the control techniques described herein. The set of instructions could be embedded in said one or more electronic processors. Alternatively, the set of instructions could be provided as software to be executed on said computational device. The controller may be implemented in software run on one or more processors. One or more other controllers may be implemented in software run on one or more processors, optionally the same one or more processors as the controller. Other arrangements are also useful.

Within the scope of this application it is expressly envisaged that the various aspects, embodiments, examples and alternatives set out in the preceding paragraphs, in the claims and/or in the following description and drawings, and in particular the individual features thereof, may be taken independently or in any combination. Features described in connection with one embodiment are applicable to all embodiments, unless such features are incompatible.

For the avoidance of doubt, it is to be understood that features described with respect to one aspect of the invention may be included within any other aspect of the invention, alone or in appropriate combination with one or more other features.

### BRIEF DESCRIPTION OF THE DRAWINGS

One or more embodiments of the invention will now be described, by way of example only, with reference to the accompanying figures in which:

FIG. 1 is a schematic illustration of a vehicle according to an embodiment of the present invention;

FIG. 2 is a block diagram to illustrate a vehicle control system in accordance with an embodiment of the invention, including various vehicle subsystems under the control of the vehicle control system;

FIG. 3 is a table showing which vehicle subsystem configuration mode is selected in each respective vehicle operating mode;

FIG. 4 is a flow diagram illustrating a method of operation of a vehicle according to an embodiment of the present invention.

### DETAILED DESCRIPTION

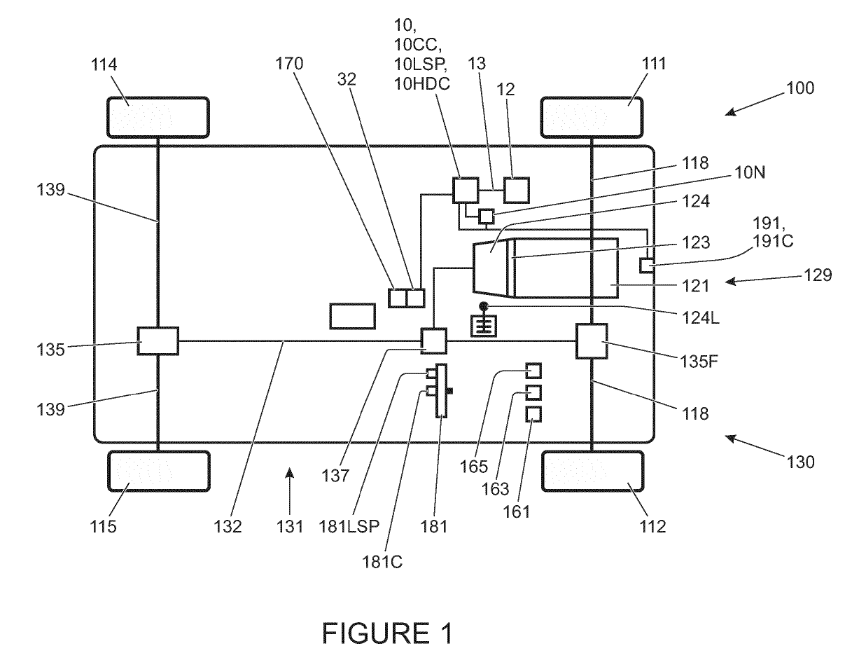

FIG. 1 shows a vehicle 100 according to an embodiment of the invention intended to be suitable for off-road use, that is for use on terrains other than regular tarmac road, as well as on-road. The vehicle 100 has a powertrain 129 that includes an engine 121 that is connected to a driveline 130 having a transmission 124. The transmission 124 is a manual transmission 124, the vehicle 100 having a gear shift lever 124L permitting a driver to select the required gear in which the transmission 124 is to be operated. A clutch 123 is provided, operated by means of a clutch pedal 165, that permits the transmission 124 to be disconnected from the engine 121 when a gear shift operation is performed.

In some alternative embodiments the powertrain 129 may be a “clutchless” powertrain in which clutch pedal 165 is omitted. In some such embodiments, the powertrain 129 may be configured such that when the gear shift lever 124L is moved from a position corresponding to the selection of one gear to a position corresponding to the selection of a different gear, the powertrain 129 automatically decouples the engine 121 from the transmission 124 before changing gear, and automatically recouples the engine 121 to the transmission 124 after changing gear. Other arrangements may be useful in some embodiments.

The driveline 130 is arranged to drive a pair of front vehicle wheels 111,112 by means of a front differential 135F and a pair of front drive shafts 118. The driveline 130 also comprises an auxiliary driveline portion 131 arranged to drive a pair of rear wheels 114, 115 by means of an auxiliary driveshaft or prop-shaft 132, a rear differential 135 and a pair of rear driveshafts 139. It is to be understood that embodiments of the present invention are suitable for use with vehicles in which the transmission 124 is arranged to drive only a pair of front wheels or only a pair of rear wheels (i.e. front wheel drive vehicles or rear wheel drive vehicles) or selectable two wheel drive/four wheel drive vehicles, or permanent four wheel drive vehicles. In the embodiment of FIG. 1 the transmission 124 is releasably connectable to the auxiliary driveline portion 131 by means of a power transfer unit (PTU) 137, allowing selectable two wheel drive or four wheel drive operation. It is to be understood that embodiments of the invention may be suitable for vehicles having more than four wheels or where only two wheels are driven, for example two wheels of a three wheeled vehicle or four wheeled vehicle or a vehicle with more than four wheels.

The PTU 137 is operable in a ‘high ratio’ or a ‘low ratio’ configuration, in which a gear ratio between an input shaft and an output shaft thereof is selected to be a high or low ratio. The high ratio configuration is suitable for general on-road or ‘on-highway’ operations whilst the low ratio configuration is more suitable for negotiating certain off-road terrain conditions and other low speed applications such as towing.

The vehicle 100 has an accelerator pedal 161 and a brake pedal 163 in addition to the clutch pedal 165, and a steering wheel 181. The steering wheel 181 has a cruise control selector button 181C mounted thereto for activating an on-highway cruise control system 10CC that is implemented in software by a vehicle central controller, referred to as a vehicle control unit (VCU) 10 described in more detail below. The steering wheel 181 is also provided with a low speed progress control system selector button 181LSP for selecting operation of a low speed progress (LSP) control system 10LSP which may also be referred to as an off-road speed control system or off-road cruise control system. The LSP control system 10LSP is also implemented in software by the VCU 10. In addition to the cruise control system 10CC and LSP control system 10LSP the VCU 10 is configured to implement a hill descent control (HDC) system 10HDC that limits maximum vehicle speed when descending an incline by automatic application of a brakes system 12d described in more detail below. The HDC system 10HDC may be activated via human machine interface (HMI) module 32.

The VCU 10 receives and outputs a plurality of signals to and from various sensors and subsystems 12 provided on the vehicle 100.

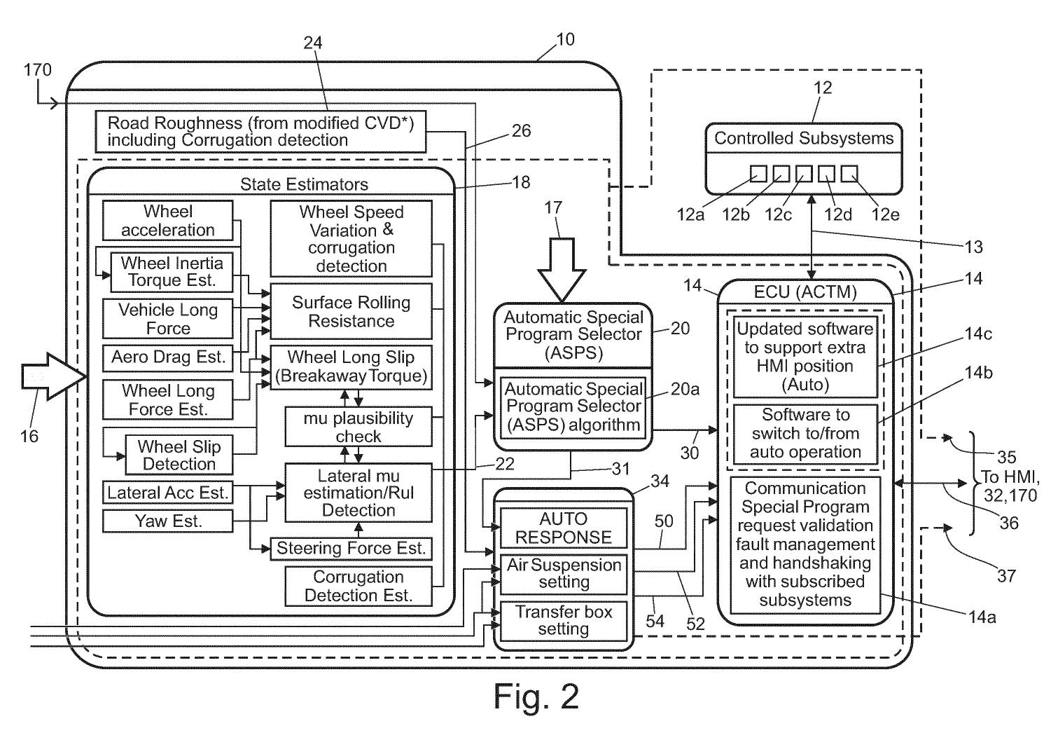

FIG. 2 is a schematic diagram illustrating operation of the VCU 10 in more detail. The VCU 10 controls a plurality of vehicle subsystems 12 including, but not limited to, an engine management system 12a, a transmission system 12b, an electronic power assisted steering unit 12c (ePAS unit), the brakes system 12d and a suspension system 12e. These vehicle sub-systems can be considered to form a first group of subsystems. Although five subsystems are illustrated as being under the control of the VCU 10, in practice a greater number of vehicle subsystems may be included on the vehicle and may be under the control of the VCU 10. The VCU 10 includes a subsystem control module 14 which provides control signals via line 13 to each of the vehicle subsystems 12 to initiate control of the subsystems in a manner appropriate to the driving condition, such as the terrain, in which the vehicle is travelling (referred to as the terrain condition). The subsystems 12 also communicate with the subsystems control module 14 via signal line 13 to feedback information on subsystem status. In some embodiments, instead of an ePAS unit 12c, a hydraulically operated power steering unit may be provided.

The VCU 10 receives a plurality of signals, represented generally at 16 and 17, from a plurality of vehicle sensors and are representative of a variety of different parameters associated with vehicle motion and status. As described in further detail below, the signals 16, 17 provide, or are used to calculate, a plurality of driving condition indicators which are indicative of the nature of the condition in which the vehicle is travelling. One advantageous feature of some embodiments of the present invention is that the VCU 10 determines the most appropriate control mode for the various subsystems on the basis of the driving condition indicators, and automatically controls the subsystems accordingly. That is, the VCU 10 determines the most appropriate control mode on the basis of the driving condition indicators and automatically causes each of the subsystems 12 to operate in the respective subsystem configuration mode corresponding to that control mode.

The sensors (not shown) on the vehicle include, but are not limited to, sensors which provide continuous sensor outputs 16 to the VCU 10, including wheel speed sensors, an ambient temperature sensor, an atmospheric pressure sensor, tire pressure sensors, yaw sensors to detect yaw, roll and pitch of the vehicle, a vehicle speed sensor, a longitudinal acceleration sensor, an engine torque sensor (or engine torque estimator), a steering angle sensor, a steering wheel speed sensor, a gradient sensor (or gradient estimator), a lateral acceleration sensor (part of a stability control system (SCS)), a brake pedal position sensor, an accelerator pedal position sensor and longitudinal, lateral and vertical motion sensors. In some other embodiments, only a selection of the aforementioned sensors may be used.

The VCU 10 also receives a signal from the electronic power assisted steering unit (ePAS unit 12c) of the vehicle 100 to indicate the steering force that is applied to the wheels (steering force applied by the driver combined with steering force applied by the ePAS unit 12c).

The vehicle 100 is also provided with a plurality of sensors which provide discrete sensor output signals 17 to the VCU 10, including a cruise control status signal (ON/OFF), a transfer box or PTU 137 status signal (whether the gear ratio is set to a HI range or a LO range), a Hill Descent Control (HDC) status signal (ON/OFF), a trailer connect status signal (ON/OFF), a signal to indicate that the Stability Control System (SCS) has been activated (ON/OFF), a windscreen wiper signal (ON/OFF), an air suspension ride-height status signal (HI/LO), and a Dynamic Stability Control (DSC) signal (ON/OFF).

The VCU 10 includes an evaluation means in the form of an estimator module or processor 18 and a calculation and selection means in the form of a selector module or processor 20. Initially the continuous outputs 16 from the sensors are provided to the estimator module 18 whereas the discrete signals 17 are provided to the selector module 20.

Within a first stage of the estimator module 18, various ones of the sensor outputs 16 are used to derive a number of driving condition indicators. In a first stage of the estimator module 18, a vehicle speed is derived from the wheel speed sensors, wheel acceleration is derived from the wheel speed sensors, the longitudinal force on the wheels is derived from the vehicle longitudinal acceleration sensor, and the torque at which wheel slip occurs (if wheel slip occurs) is derived at least in part from a knowledge of instantaneous engine torque. Other calculations performed within the first stage of the estimator module 18 include the wheel inertia torque (the torque associated with accelerating or decelerating the rotating wheels), “continuity of progress” (the assessment of whether the vehicle is starting and stopping, for example as may be the case when the vehicle is travelling over rocky terrain), aerodynamic drag, yaw rate, and lateral vehicle acceleration.

The estimator module 18 also includes a second stage in which the following driving condition indicators are calculated: surface rolling resistance (based on the wheel inertia torque, the longitudinal force on the vehicle, aerodynamic drag, and the longitudinal force on the wheels), the steering force on the steering wheel 181 (based on the lateral acceleration and the output from the steering wheel sensor), the wheel longitudinal slip (based on the longitudinal force on the wheels, the wheel acceleration, SCS activity and a signal indicative of whether wheel slip has occurred), lateral friction (calculated from the measured lateral acceleration and the yaw versus the predicted lateral acceleration and yaw), and corrugation detection (high frequency, low amplitude wheel height excitement indicative of a washboard type surface). Longitudinal friction or ‘surface mu’ (that is, surface coefficient of friction in a longitudinal direction with respect to the vehicle) may also be calculated by the estimator module 18. In some alternative embodiments the value of surface mu may be received by the estimator module 18 and not calculated by the estimator module 18.

The SCS activity signal is derived from several outputs from an SCS ECU (not shown), which contains the DSC (Dynamic Stability Control) function, the TC (Traction Control) function, ABS and HDC algorithms, indicating DSC activity, TC activity, ABS activity, brake interventions on individual wheels, and engine torque reduction requests from the SCS ECU to the engine 121. All these indicate a slip event has occurred and the SCS ECU has taken action to control it. The estimator module 18 also uses the outputs from the wheel speed sensors to determine a wheel speed variation and corrugation detection signal.

On the basis of the windscreen wiper signal (ON/OFF), the estimator module 18 also calculates how long the windscreen wipers have been in an ON state (i.e. a rain duration signal).

The VCU 10 also includes a road roughness module 24 for calculating the terrain roughness based on the air suspension sensors (the ride height sensors) and the wheel accelerometers. A driving condition indicator signal in the form of a roughness output signal 26 is output from the road roughness module 24.

The estimates for the wheel longitudinal slip and the lateral friction estimation are compared with one another within the estimator module 18 as a plausibility check.

Calculations for wheel speed variation and corrugation output, the surface rolling resistance estimation, the wheel longitudinal slip and the corrugation detection, together with the friction plausibility check, are output from the estimator module 18 and provide driving condition indicator output signals 22, indicative of the nature of the terrain in which the vehicle is travelling, for further processing within the VCU 10.

The driving condition indicator signals 22 from the estimator module 18 are provided to the selector module 20 for determining which of a plurality of vehicle subsystem control modes (and therefore corresponding subsystem configuration modes) is most appropriate based on the indicators of the type of terrain in which the vehicle is travelling. The most appropriate control mode is determined by analyzing the probability that each of the different control modes is appropriate on the basis of the driving condition indicator signals 22, 26 from the estimator module 18 and the road roughness module 24.

The vehicle subsystems 12 may be controlled automatically in a given subsystem control mode (in an “automatic mode” or “automatic condition” of operation of the VCU 10) in response to a control output signal 30 from the selector module 20 and without the need for driver input. Alternatively, the vehicle subsystems 12 may be operated in a given subsystem control mode according to a manual user input (in a “manual mode” or “manual condition” of operation of the VCU 10) via the HMI module 32. Thus in the manual mode of operation the user determines in which subsystem control mode the subsystems will be operated by selection of a required system control mode (operating mode). The HMI module 32 comprises a display screen (not shown) and a user operable switchpack 170. The user may select between the manual and automatic modes (or conditions) of operation of the VCU 10 via the switchpack 170. When the VCU 10 is operating in the manual mode or condition, the switchpack 170 also allows the user to select the desired subsystem control mode.

It is to be understood that the subsystem controller 14 may itself control the vehicle subsystems 12a-12e directly via the signal line 13, or alternatively each subsystem may be provided with its own associated intermediate controller (not shown in FIG. 1) for providing control of the relevant subsystem 12a-12e. In the latter case the subsystem controller 14 may only control the selection of the most appropriate subsystem control mode for the subsystems 12a-12e, rather than implementing the actual control steps for the subsystems. The or each intermediate controller may in practice form an integral part of the main subsystem controller 14.

When operating in the automatic mode, the selection of the most appropriate subsystem control mode may be achieved by means of a three phase process:

(1) for each type of control mode, a calculation is performed of the probability that the control mode is suitable for the terrain over which the vehicle is travelling, based on the driving condition indicators;

(2) the integration of “positive differences” between the probability for the current control mode and the other control modes; and

(3) the program request to the control module 14 when the integration value exceeds a pre-determined threshold or the current terrain control mode probability is zero.

The specific steps for phases (1), (2) and (3) will now be described in more detail.

In phase (1), the continuous driving condition indicator signals in the form of the road surface roughness output 26 and the outputs 22 from the estimator module 18 are provided to the selector module 20. The selector module 20 also receives the discrete driving condition indicators 17 directly from various sensors on the vehicle, including the transfer box (PTU 137) status signal (whether the gear ratio is set to a HI range or a LO range), the DSC status signal, cruise control status (whether the vehicle's cruise control system 11 is ON or OFF), and trailer connect status (whether or not a trailer is connected to the vehicle). Driving condition indicator signals indicative of ambient temperature and atmospheric pressure are also provided to the selector module 20. The estimator module also receives a signal indicative of the position of clutch pedal 165 and the position of gear lever 124L. In some embodiments, in addition to or instead of receiving a signal indicative of the position of gear level 124L the estimator module may receive a signal indicative of the selected gear configuration of the transmission, 124, that is whether the transmission is in a reverse gear configuration, a neutral configuration, or a forward driving gear configuration.

The selector module 20 is provided with a probability algorithm 20a for calculating the most suitable control mode for the vehicle subsystems 12a-e based on the discrete driving condition indicator signals 17 received directly from the sensors and the continuous driving condition indicators 22, 26 calculated by the estimator module 18 and the road surface roughness module 24, respectively. That is, the probability algorithm 20a calculates the most suitable system control mode, which determines the respective subsystem configuration mode in which each subsystem is to be operated, based on the discrete driving condition indicator signals 17 and the continuous driving condition indicators 22, 26.

The control modes typically include a grass/gravel/snow control mode (GGS mode) that is suitable for when the vehicle is travelling in grass, gravel or snow terrain, a mud/ruts control mode (MR mode) which is suitable for when the vehicle is travelling in mud and ruts terrain, a rock crawl/boulder mode (RB mode) which is suitable for when the vehicle is travelling in rock or boulder terrain, a sand mode which is suitable for when the vehicle is travelling in sand terrain (or deep soft snow) and a special programs OFF mode (SP OFF mode or SPO mode) which is a suitable compromise mode, or general mode, for all terrain conditions and especially vehicle travel on motorways and regular roadways. Many other control modes are also envisaged including those disclosed in US2003/0200016, the content of which is hereby incorporated by reference.

The different terrain types are grouped according to the friction of the terrain and the roughness of the terrain. For example, it is appropriate to group grass, gravel and snow together as terrains that provide a low friction, smooth surface and it is appropriate to group rock and boulder terrains together as high friction, very high roughness terrains.

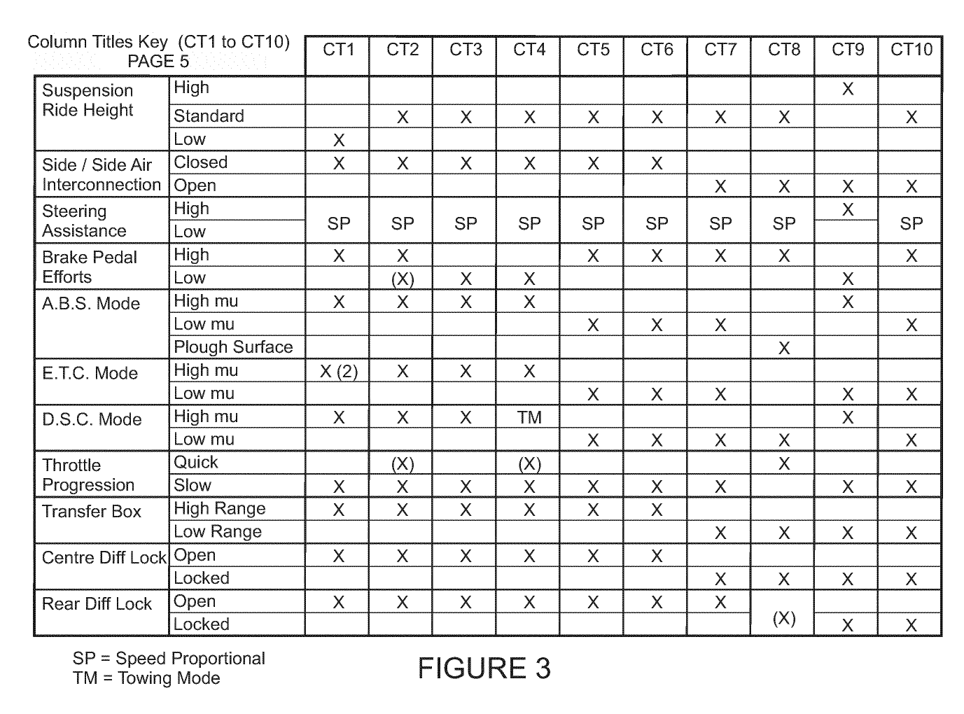

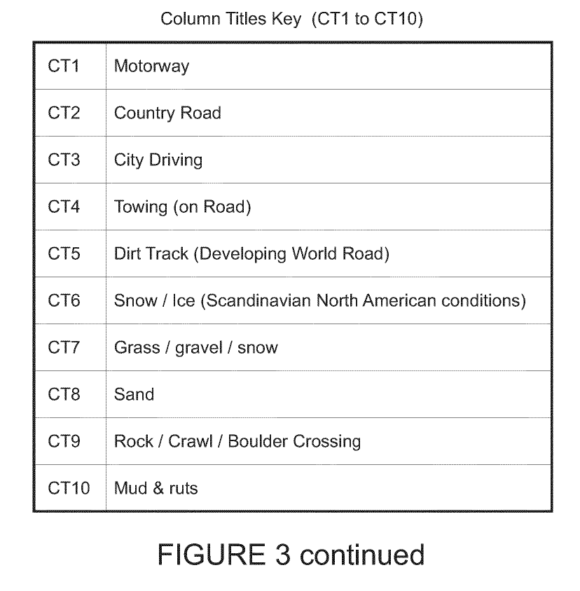

FIG. 3 is a table taken from US2003/0200016 showing the particular sub-system configuration modes that may be assumed by the subsystems 12 of a vehicle according to some embodiments of the invention in the respective different driving modes or operating modes in which the VCU 10 may operate in some embodiments. These operating modes may be considered to be sub-system control modes.

The driving modes are:

(a) A motorway (or highway) mode;

(b) A country road mode;

(c) A city driving (urban) mode;

(d) A towing (on-road) mode;

(e) A dirt track mode;

(f) A snow/ice (on-road) mode;

(g) A GGS mode;

(h) A sand mode;

A rock crawl or boulder crossing mode (RB); and A mud/ruts (MR) mode

In the present embodiment, the vehicle 100 is limited to operating in the GGS mode, MR mode, RB mode, Sand mode and SPO mode, however it will be appreciated that the invention is not limited to such an arrangement and any combination of on and off road control modes may be used within the scope of the present invention.

With reference to FIG. 3, the configuration of the suspension system 12e is specified in terms of ride height (high, standard or low) and side/side air interconnection. The suspension system 12e is a fluid suspension system, in the present embodiment an air suspension system, allowing fluid interconnection between suspensions for wheels on opposite sides of the vehicle in the manner described in US2003/0200016. The plurality of subsystem configuration modes provide different levels of said interconnection, in the present case no interconnection (interconnection closed) and at least partial interconnection (interconnection open).

The configuration of the ePAS steering unit 12c may be adjusted to provide different levels of steering assistance, wherein steering wheel 181 is easier to turn the greater the amount of steering assistance. The amount of assistance may be proportional to vehicle speed in some driving modes.

The brakes system 12d may be arranged to provide relatively high brake force for a given amount of pressure applied to the brake pedal 163 or a relatively low brake force, depending on the driving mode.

The brakes system 12d may also be arranged to allow different levels of wheel slip when an anti-lock braking system is active, (relatively low amounts on low friction (“low-mu” surfaces) and relatively large amounts on high friction surfaces).

An electronic traction control (ETC) system may be operated in a high mu or low mu configuration, the system tolerating greater wheel slip in the low mu configuration before intervening in vehicle control compared with the high mu configuration.

A dynamic stability control system (DSC) may also be operated in a high mu or low mu configuration.

The engine management system 12a may be operated in ‘quick’ or ‘slow’ accelerator (or throttle) pedal progression configuration modes in which an increase in engine torque as a function of accelerator pedal progression is relatively quick or slow, respectively. The rate may be dependent on speed in one or more modes such as Sand mode.

The PTU 137 may be operated in a high range (HI) subsystem configuration mode or low range (LO) subsystem configuration mode as described herein.

In some embodiments, a center differential and a rear differential each include a clutch pack and are controllable to vary the degree of locking between a “fully open” and a “fully locked” state. The actual degree of locking at any one time may be controlled on the basis of a number of factors in a known manner, but the control can be adjusted so that the differentials are “more open” or “more locked”. Specifically the pre-load on the clutch pack can be varied which in turn controls the locking torque, i.e. the torque across the differential that will cause the clutch, and hence the differential, to slip. A front differential could also be controlled in the same or similar way.

For each driving mode (subsystem control mode), i.e. GGS, MR, RB, Sand or SPO in the present embodiment, the algorithm 20a within the selector module 20 performs a probability calculation, based on the driving condition indicators, to determine a probability that each of the different control modes is appropriate. The selector module 20 includes a tuneable data map which relates the continuous driving condition indicators 22, 26 (e.g. vehicle speed, road roughness, steering angle) to a probability that a particular control mode is appropriate. Each probability value typically takes a value of between 0 and 1. So, for example, the vehicle speed calculation may return a probability of 0.7 for the RB mode if the vehicle speed is relatively low, whereas if the vehicle speed is relatively high the probability for the RB mode will be much lower (e.g. 0.2). This is because it is much less likely that a high vehicle speed is indicative that the vehicle is travelling over a rock or boulder terrain.

In addition, for each subsystem control mode, each of the discrete driving condition indicators 17 (e.g. trailer connection status ON/OFF, cruise control status ON/OFF) is also used to calculate an associated probability for each of the control modes, GGS, RB, Sand, MR or SP OFF. So, for example, if cruise control is switched on by the driver of the vehicle, the probability that the SP OFF mode is appropriate is relatively high, whereas the probability that the MR control mode is appropriate will be lower.

For each of the different subsystem control modes, a combined probability value, Pb, is calculated based on the individual probabilities for that control mode, as described above, as derived from each of the continuous or discrete driving condition indicators 17, 22, 26. In the following equation, for each control mode the individual probability as determined for each driving condition indicator is represented by a, b, c, d . . . n. The combined probability value, Pb, for each control mode is then calculated as follows:

Pb=(a.b.c.d. . . . n)/((a.b.c.d . . . n)+(1−a).(1−b).(1−c).(1−d). . . . (1−n))

Any number of individual probabilities may be input to the probability algorithm 20a and any one probability value input to the probability algorithm may itself be the output of a combinational probability function.

Once the combined probability value for each control mode has been calculated, the subsystem control program corresponding to the control mode with the highest probability is selected within the selector module 20. The benefit of using a combined probability function based on multiple driving condition indicators is that certain indicators may make a control mode (e.g. GGS or MR) more or less likely when combined together, compared with basing the selection on just a single driving condition indicator alone.

In phase (2), an integration process is implemented continually within the selector module 20 to determine whether it is necessary to change from the current control mode to one of the alternative control modes.

The first step of the integration process is to determine whether there is a positive difference between the combined probability value for each of the alternative control modes compared with the combined probability value for the current control mode.

By way of example, assume the current control mode is GGS with a combined probability value of 0.5. If a combined probability value for the sand control mode is 0.7, a positive difference is calculated between the two probabilities (i.e. a positive difference value of 0.2). The positive difference value is integrated with respect to time. If the difference remains positive and the integrated value reaches a predetermined change threshold (referred to as the change threshold), or one of a plurality of predetermined change thresholds, the selector module 20 determines that the current terrain control mode (GGS) is to be updated to a new, alternative control mode (in this example, the sand control mode). A control output signal 30 is then output from the selector module 20 to the subsystem control module 14 to initiate the sand control mode for the vehicle subsystems.

In phase (3), the probability difference is monitored and if, at any point during the integration process, the probability difference changes from a positive value to a negative value, the integration process is cancelled and reset to zero. Similarly, if the integrated value for one of the other alternative control modes (i.e. other than the currently selected control mode, in the present example the sand control mode) reaches the predetermined change threshold before the probability result for the sand control mode, the integration process for the sand control mode is cancelled and reset to zero and the other alternative control mode, with a higher probability difference, is selected.

A further control signal 31 from the selector module 20 is provided to a control module 34. The outputs from the control module 34 to the subsystem control module 14 include a transfer box (PTU 137) setting signal 54 indicative of the setting (HI/LO) of the PTU 137, an air suspension setting signal 52 indicative of the air suspension configuration such as ride height, and a further signal 50. In the sub-system control module 14 a validation check or fault detection process 14a is carried out. The validation and fault detection process 14a operates so as to ensure that if one of the subsystems cannot support a selected control mode, for example because of a fault, appropriate action is taken (e.g. in the form of a warning).

### Driver System Selection

As noted above, the vehicle 100 has a HDC system 10HDC and an LSP control system 10LSP for controlling vehicle speed when driving in off-road conditions. The vehicle 100 also has a navigation system 10N that is configured to operate in either an on-road mode or an off-road mode. The navigation system 10N is operated by a driver via the HMI module 32 and the system 10N displays the location of the vehicle 100 with respect to a map by means of the display screen of the HMI module 32. The system 10N determines vehicle location by means of an inbuilt global positioning system (GPS) and accesses a database of maps to display a map of an instant location of the vehicle 100. When the off-road mode is selected, the navigation system 10N accesses a database of off-road terrain information whilst when in the on-road or highway mode the system 10N accesses a database of information in respect of known roads. In some embodiments location determining means other than a GPS system may be employed such as a general packet radio service (GPRS) or other means.

The vehicle 100 also has an off-road camera system 191 having a forward-facing camera 191C that is configured to provide a video feed to the HMI module 32 via the VCU 10. The off-road camera system 191 may be activated via the HMI module 32 and a video feed from the camera 191C may be displayed on the display screen of the HMI module 32.

The HDC control system 10HDC, LSP control system 10LSP, navigation system 10N and off-road camera system 191 may be considered to be a second group of sub-systems of the vehicle.

The VCU 10 is configured to monitor the state of HDC control system 10HDC, LSP control system 10LSP, navigation system 10N and off-road camera system 191. In the case of the navigation system 10N, the VCU 10 is configured to monitor the mode in which the navigation system 10N is operated. The VCU 10 is configured such that each of the systems 10HDC, 10LSP, 10N, 191 has an associated terrain indicator, designated by way of example as e(HDC), e(LSP), e(ORNAV) and e(ORCAM) respectively. The VCU 10 is configured to set each of these terrain indicators to a predetermined value in dependence on the state of the respective system.

In the case of the HDC control system 10HDC, LSP control system 10LSP and off-road camera system 191, if the system 10HDC, 10LSP, 191 is in an active or in-use condition the VCU 10 sets the associated terrain indicator e(HDC), e(LSP), or e(ORCAM) to a value of 0.6. If the system is not in an active or in-use condition the associated terrain indicator e(HDC), e(LSP) or e(ORCAM) is set to a reference value, in the present embodiment a reference value of 0.5.

In the case of the navigation system 10N, the system sets the terrain indicator e(ORNAV) to a value higher than the reference value, in the present embodiment a value of 0.6, if the navigation system 10N is in the off-road mode. If the navigation system is in the on-road mode or not in an active or in-use condition the terrain indicator e(ORNAV) is set to the reference value of 0.5.

It is to be understood that values other than 0.5 and/or 0.6 may be useful in some embodiments, and that different ones of the second group of sub-systems may have different values.

In turn, for each off-road driving mode in which a given system 10HDC, 10LSP, 191 might be selected by a driver, or in the case of the navigation system 10N, the system 10N operated in the off-road mode, the VCU 10 is configured to include the respective associated terrain indicator e(HDC), e(LSP), e(ORNAV) or e(ORCAM) in the calculation of the combined probability value, Pb, for that mode. That is, the combined probability value, Pb, that that mode is the most suitable mode for the prevailing driving conditions.

It is to be understood that, by increasing the value of a terrain indicator e(HDC), e(LSP), e(NAV) or e(ORCAM) from the reference value to a value indicative of higher probability, in the present embodiment from a value of 0.5 to a value of 0.6, the combined probability value Pb will also have a corresponding increase, favoring selection of that mode in preference to a mode for which that terrain indicator is not used to calculate the combined probability value. Accordingly, it is to be understood that the combined probability value for the on-road driving mode SPO would not normally include any of terrain indicators e(HDC), e(LSP), e(ORNAV) or e(ORCAM).

In some embodiments, if the navigation system 10N is operating in the on-road mode, the value of e(ORNAV) may be reduced to a value below the reference value, in the present embodiment to a value of 0.4, since the likelihood that a vehicle is operating off-road with the navigation system 10N in the on-road mode is relatively low. A value other than 0.4 may be useful in some embodiments.

It is to be understood that, in some embodiments the combined probability value for the on-road or SPO mode may include a parameter e(HNAV) that is set to a value of 0.5 or 0.6 in dependence on whether the navigation system 10N is operating in the off-road mode or the on-road mode. The parameter e(HNAV) may be set to a value of 0.5 unless the navigation system 10N is operating in the on-road mode, in which case the parameter e(HNAV) may be set to a value of 0.6. In some embodiments, if the navigation system 10N is operating in the off-road mode, the value of e(HNAV) may be reduced below 0.5, for example to a value of 0.4, since the likelihood that a vehicle is operating on-road with the navigation system 10N in the off-road mode is relatively low.

It is to be understood that values of the terrain indicators e(HDC), e(LSP), e(ORNAV), e(HNAV) and e(ORCAM) other than 0.4, 0.5 or 0.6 may be useful in some embodiments.

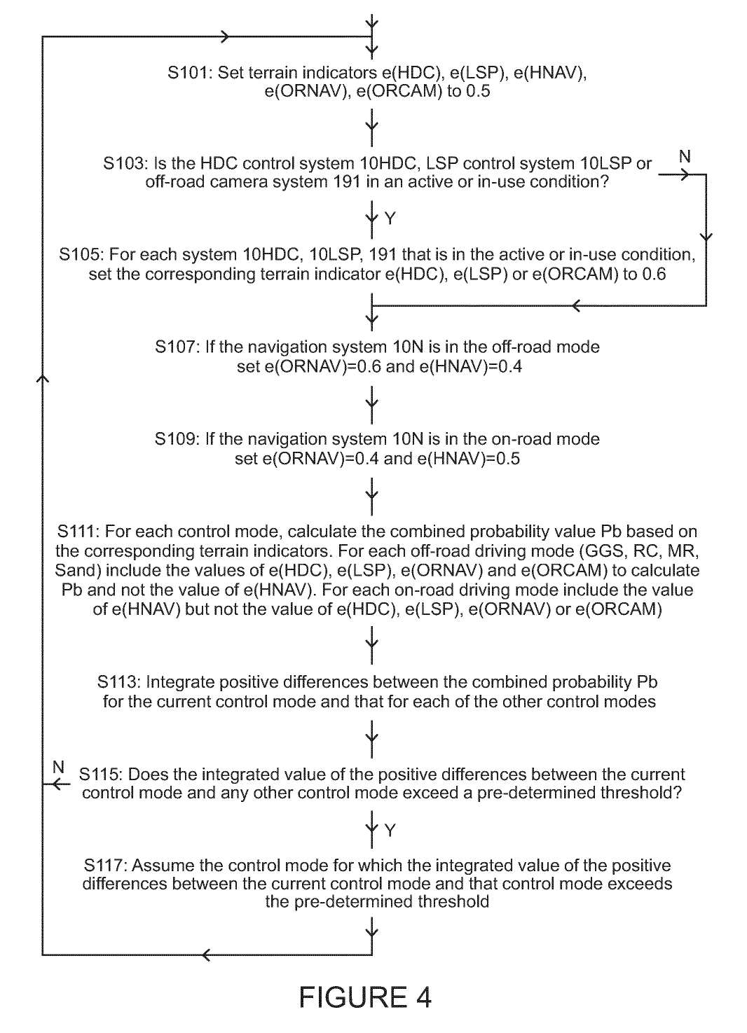

A method of controlling a vehicle according to an embodiment of the present invention will now be described with reference to FIG. 4.

At step S101 the VCU 10 sets each of the terrain indicators e(HDC), e(LSP), e(HNAV),

e(ORNAV) and e(ORCAM) to a reference value 0.5.

At step S103, the VCU 10 checks whether any one of the HDC control system 10HDC, LSP control system 10LSP or off-road camera system 191 is in an active or in-use condition. If any one of these systems are in an active or in-use condition the method continues at step S105 else the method continues at step S107.

At step S105, for each system from amongst the HDC control system 10HDC, LSP control system 10LSP or off-road camera system 191 that is in the active or in-use condition the corresponding terrain indicator e(HDC), e(LSP) or e(OR-CAM) is set to a value of 0.6.

At step S107, if the navigation system 10N is in the off-road mode the value of e(ORNAV) is set to 0.6 and the value of e(HNAV) is set to 0.4.

At step S109, if the navigation system 10N is in the on-road mode the value of e(ORNAV) is set to 0.4 and the value of e(HNAV) is set to 0.5.

At step S111, for each control mode, the VCU 10 calculates the combined probability value Pb based on the corresponding terrain indicators. For each off-road driving mode (GGS, RC, MR, Sand) the VCU 10 includes the values of e(HDC), e(LSP), e(ORNAV) and e(ORCAM) in the calculation of the value of Pb but not the value of e(HNAV). For each on-road driving mode (in the present embodiment, the SPO mode) the VCU 10 includes the value of e(HNAV) in calculating Pb but not the value of e(HDC), e(LSP), e(ORNAV) or e(ORCAM).

At step S113 the VCU 10 integrates the positive differences between the combined probability Pb for the current control mode and that for each of the other control modes.

At step S115 the VCU 10 determines whether the integrated value of the positive differences between the current control mode and any other control mode exceeds a pre-determined threshold. If this condition is met the VCU 10 continues at step S117 else the VCU 10 continues at step S101.

At step S117 the VCU 10 assumes the control mode for which the integrated value of the positive differences between the combined probability of the current control mode and that control mode exceeds the pre-determined threshold. The method then continues at step S101.

It is to be understood that the integration performed at step S113 may be incremental each time the VCU 10 loops through steps S101 to S115 (as appropriate). That is, integration of values is performed over a series of loops through steps S101 to S115.

Some embodiments of the present invention have the advantage that vehicle composure may be preserved and in some embodiments or situations composure may be enhanced by increasing the probability that the VCU 10 selects the most appropriate control mode at a given moment in time. Some embodiments have the advantage that user confidence in vehicle operation, performance and expected response may be enhanced. In some embodiments automatic terrain recognition and control mode selection may be made with greater confidence.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

1. A vehicle control system comprising:
a subsystem controller configured to initiate control of a first group of at least one vehicle subsystem in a selected one of a plurality of subsystem control modes, wherein each of which subsystem control modes corresponds to one or more different driving conditions for the vehicle, the control modes including at least one on-road driving mode and at least one off-road driving mode;
an estimator module configured to evaluate at least one driving condition indicator to determine the extent to which each of the subsystem control modes is appropriate and configured to provide an output indicative of the subsystem control mode that is most appropriate, said at least one driving condition indicator including at least one terrain indicator indicative of the type of terrain over which the vehicle is travelling,
wherein said at least one terrain indicator comprises a signal indicative of whether one or more subsystems of a second group of one or more sub-systems is operational, the estimator module being configured to increase the probability to which said at least one off-road driving mode is determined appropriate in dependence on the at least one terrain indicator;
wherein the second group of one or more subsystems are associated with off-road driving; and wherein
in an automatic response mode said subsystem controller selects the most appropriate one of the subsystem control modes for the or each subsystem of the first group in dependence on the output.

2. A vehicle control system as claimed in claim 1 wherein:
said subsystem controller and said estimator module comprises at least one electronic processor having an electrical input for receiving said one or more signals each indicative of a driving condition indicator, and
an electronic memory device electrically coupled to the electronic processor and having instructions stored therein,
said estimator module being configured to increase the probability to which said at least one off-road driving mode is determined appropriate in dependence on the at least one terrain indicator, and said subsystem controller being configured to select the most appropriate one of the subsystem control modes for the or each subsystem of the first group in dependence on the output, comprises the processor being configured to access the memory device and execute the instructions stored therein such that it is operable to increase the probability to which said at least one off-road driving mode is determined appropriate in dependence on the at least one terrain indicator and select the most appropriate one of the subsystem control modes.

3. A vehicle control system according to claim 1 configured to receive an input indicative of the operational state of the one or more subsystems of the second group, and wherein the operational states of the second group of one or more subsystems include at least one active state and at least one inactive state.

4. A vehicle control system according to claim 1, wherein the subsystems of the second group include at least one selected from amongst an off-road speed control system, an off-road navigation system and an off-road camera system.

5. (canceled)

6. A vehicle control system according to claims 3, wherein the operational state of at least one subsystem of the second group corresponds to a user-selectable operational state of the subsystem.

7. A vehicle control system according to claim 1, wherein the estimator module is configured to increase the probability that an off-road driving mode and not an on-road driving mode is selected when a subsystem of the second group is in an active state.

8. A vehicle control system according to claim 1, wherein the estimator module is arranged to determine the probability that each of the subsystem control modes is appropriate, and wherein the output provided by the estimator module is indicative of the subsystem control mode with the highest probability.

9. A vehicle control system according to claim 1, wherein the subsystem controller is also arranged to control the or each of the vehicle subsystems in the selected one of the plurality of control modes.

10. A vehicle control system according to claim 1, wherein the estimator module further includes a selector module for calculating a combined probability value for each subsystem control mode based on individual probability values, for said subsystem control mode, derived from a respective one of the driving condition indicators, the control output signal from the estimator module being indicative of the control mode with the highest combined probability value,
wherein the probability value for at least one said at least one off-road driving mode is adjusted to favor said at least one off-road driving mode in dependence on at least one said at least one terrain indicator that comprises a signal indicative of whether one or more subsystems of a second group of one or more sub-systems is operational.

11. A vehicle control system according to claim 10, wherein the combined probability value (Pb) for each control mode is calculated by:
Pb=(a.b.c.d. . . . n)/((a.b.c.d . . . n)+(1−a).(1−b).(1−c).(1−d) . . . . (1−n))
wherein a, b, c, d . . . n represent the individual probability values derived from respective ones of the driving condition indicators.

12. A vehicle control system according to claim 1, comprising:
a selector module configured to:
calculate, for each of the control modes, a difference value between the probability for the current control mode and the probability for another control mode,
integrate each of the difference values with respect to time to calculate an integrated difference value for each of the other control modes,
compare each of the integrated difference values with a threshold for change, and
initiate a change in the selected subsystem control mode when the integrated difference value for one of the control modes exceeds the threshold for change.

13. A vehicle control system according to claim 12 wherein:
said selector module comprises
at least one electronic processor having an electrical input for receiving said one or more signals each indicative of a driving condition indicator, and
an electronic memory device electrically coupled to the electronic processor and having instructions stored therein;
the processor being configured to access the memory device and execute the instructions stored therein such that it is operable to: calculate, for each of the control modes, a difference value between the probability for the current control mode and the probability for another control mode; integrate each of the difference values with respect to time to calculate an integrated difference value for each of the other control modes, compare each of the integrated difference values with a threshold for change; and initiate a change in the selected subsystem control mode when the integrated difference value for one of the control modes exceeds the threshold for change.

14. A vehicle control system according to claim 12, wherein the selector module is configured to compare each of the integrated difference values with a plurality of thresholds for change and is configured to initiate a change in the selected subsystem control mode when a first one of the thresholds for change is reached.

15. A vehicle control system according to claim 14, wherein each threshold for change is variable in dependence on a different driving condition indicator.

16. A vehicle control system according to claim 15, wherein one of the thresholds for change is dependent on at least one of a surface roughness of the terrain in which the vehicle is travelling, and a rolling resistance of the terrain in which the vehicle is travelling.

17. (canceled)

18. A vehicle control system according to claim 1, further including a switch that enables switching between the automatic response mode in which the automatic control means controls the vehicle subsystems in dependence on the output automatically, and a manual response mode in which the subsystem control mode is selected by the driver manually.

19. (canceled)

20. A vehicle comprising the at least one vehicle subsystem and a vehicle control system according to claim 1, wherein the at least one vehicle subsystem includes one more of: an engine management system, a steering controller, a brakes controller and a suspension controller.

21. (canceled)

22. A method of controlling at least one vehicle subsystem of a vehicle, the method comprising:
initiating control of a first group of at least one vehicle subsystem in a selected one of a plurality of subsystem control modes, each of which corresponds to one or more different driving conditions for the vehicle, the control modes including at least one on-road driving mode and at least one off-road driving mode;
evaluating at least one driving condition indicator to determine the extent to which each of the subsystem control modes is appropriate;
providing an output indicative of the subsystem control mode that is most appropriate, said at least one driving condition indicator including at least one terrain indicator indicative of the type of terrain over which the vehicle is travelling, the at least one terrain indicator including a signal indicative of whether one or more subsystems of a second group of one or more sub-systems is operational, wherein the second group of one or more subsystems are associated with off-road driving,
the method comprising evaluating at least one said at least one terrain indicator that is indicative of the state of one or more vehicle sub-systems of the second group of one or more sub-systems and increasing the probability that at least one off-road driving mode is selected in dependence thereon; and
automatically selecting the most appropriate one of the subsystem control modes for the or each subsystem of the first group in dependence on the output.

23. A method according to claim 22, wherein evaluating at least one driving condition indicator comprises determining the probability that each of the subsystem control modes is appropriate and providing an output indicative of the control mode with the highest probability.

24. (canceled)

25. A non-transitory computer readable medium having stored thereon computer program code executable on a processor so as to implement the method of claim 22.

26.-28. (canceled)
